(19) United States
(12) Patent Application Publication
(10) Pub. No.: US 2019/0366597 A1
(43) Pub. Date: Dec. 5, 2019

(54) MOLD RELEASE AGENT MONITOR AND CONTROL SYSTEM

(71) Applicant: Chem-Trend Limited Partnership, Howell, MI (US)

(72) Inventors: WANG XIAOGUANG, Yangpu (CN); Robert CURTIS, Brighton, MI (US)

(21) Appl. No.: 15/992,388

(22) Filed: May 30, 2018

(51) Int. Cl. B29C 37/00; B29C 33/58; B22C 3/00

(52) U.S. Cl. CPC B29C 37/00; B29C 2037/90; B22C 3/00; B29C 33/58

(57) ABSTRACT

A mold release agent monitoring system includes a molding tool and a supply of mold release agent is provided along with a spray device for applying the mold release agent to the molding tool. A monitoring system monitors an amount of mold release agent applied to the molding tool during a discrete spray cycle. The mold release agent monitoring system provides an output signal to an indicator system for indicating an amount of mold release agent applied during the prior discrete spray cycle. The monitoring system also monitors a total consumption of mold release agent over a determined time period and provides a warning to a consumer of a need to reorder more mold release agent when a remaining mold release agent level falls below a predetermined level.

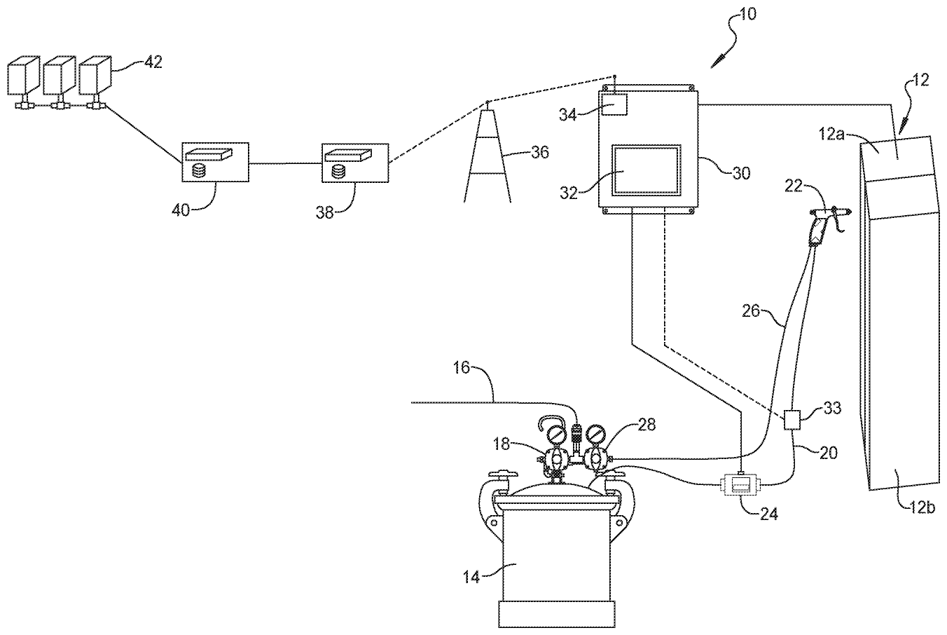

### FIELD

The present disclosure relates to a mold release agent monitor and control system.

### BACKGROUND

This section provides background information related to the present disclosure which is not necessarily prior art.

During the molding of many plastic, foam, metal and other components a mold release agent can be used to aid in the release of a molded component from the molding tool. Mold release agent is a general term for fluid supplied to a molding tool to provide ease of release, extend tool uptime, and sometimes other characteristics such as a particular part finish. The mold release agent can be sprayed or otherwise applied to the surface of the molding tool. In many mold release agent applications, too little spray volume can result in the parts not properly releasing and too much spray volume can result in material build up.

### SUMMARY

This section provides a general summary of the disclosure, and is not a comprehensive disclosure of its full scope or all of its features.

The spray monitor system of the present application provides for the automatic detection and measuring of the discrete spray cycle volumes and gives an operator immediate feedback to learn the correct application and provides data useful for optimizing the process.

The mold release agent monitoring system, includes a molding tool. A supply of mold release agent is provided along with a spray device for applying the mold release agent to the molding tool. A monitoring system monitors an amount of mold release agent applied to the molding tool during a discrete spray cycle. The mold release agent monitoring system provides an output signal to an indicator system for indicating an amount of mold release agent applied during the prior discrete spray cycle. The monitoring system also monitors a total consumption of mold release agent over a determined time period and provides a warning to a consumer of a need to reorder more mold release agent when a remaining mold release agent level falls below a predetermined level.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The FIGURE is a schematic view of a mold release agent monitoring system according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the FIGURES. Spatially relative terms may be intended to encompass different orientations of the device in use or operation in addition to the orientation depicted in the FIGURES. For example, if the device in the FIGURES is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With reference to the FIGURE a mold release agent monitoring system 10 according to the principles of the present disclosure will now be described. The mold release agent monitoring system 10 includes a molding tool 12 that include two or more molding segments 12a, 12b that combine to define a mold cavity for molding a desired part from plastic, foam, metal or other known molding material. A vessel or tank 14 is provided for holding a mold release agent. The tank 14 can be provided with pressurized air or gas 16 through a tank pressure regulator 18 or alternatively can include a pump for causing the mold release agent to travel through a fluid hose 20 to a spray gun 22. A flow meter 24 is provided in the fluid hose 20. An air hose 26 provides atomizing air from an atomizing air regulator 28 to the spray gun 22.

A spray monitor 30 in the form of a processor unit receives data from the flow meter 24 regarding the amount of mold release agent applied to the molding tool 12 during each discrete spray cycle. For purposes of this disclosure, “each discrete spray cycle” refers to the application of mold release agent to the molding tool between successive molding operations. The spray monitor 30 can be provided with a display 32 and/or other indicator device such as an audible indicator to indicate to the spray operator an amount of mold release agent applied to the molding tool 12 during each discrete spray cycle. A shutoff valve 33 can be provided in the fluid hose 20 to automatically stop the flow of release agent after a predetermined quantity of mold release agent has been sprayed during a spray cycle as monitored by the spray monitor 30. The spray monitor 30 can be in communication with an actuator of the molding tool 12 to prevent the molding tool from closing if the spray monitor 30 detects that an insufficient or an excessive amount of mold release agent has been sprayed on the molding tool 12. The spray monitor 30 can also optionally monitor the air regulator 28 for controlling the atomization for maintaining proper spray efficiency.

The spray monitor 30 can be provided with a modem 34 for communication with a wireless network 36 to communicate with a transaction manager 38 that receives data regarding the amount of mold release agent applied to the molding tool 12 during each discrete spray cycle. The transaction manager 38 can assess the real-time consumption data and give suggestions to the customer how to adjust it. Customers can change the consumption by increasing or decreasing the liquid flow which can be controlled by solenoid valves through cable or wireless communication devices to change the throughput of the spray gun 22. The transaction manager 30 can also monitor the total consumption of mold release agent and provide a signal in the form of a text, e-mail or other communication to remind the customer to order more mold release agent as supplies become low in order to avoid the possibility of shut down or to save the cost of urgent delivery. The transaction manager 38 can communicate via a web server 40 to allow customers with internet access 42 to the mold release agent use data and the transaction manager recommendations including flow adjustments and re-order warnings.

It should be understood that the mold release agent monitoring system can utilize alternative methods of determining the amount of mold release agent applied during each discrete spray cycle, including using spray duration times, pressure data and calibrated flow characteristics to calculate an amount of mold release agent used in each spray cycle. Additional methods can include using a weight of the tank 14 and averaging a discernable weight reduction over a number of spray cycles to determine an average amount of mold release agent applied per cycle.

The mold release agent monitoring system measures and displays the volume of mold release agent sprayed during a discrete spray cycle, allowing feedback to the operator as well as data collection to measure the process consistency and improve the operator performance. The spray monitor system can also control the amount of time sprayed and to collect the data remotely in real-time. The spray monitor will detect when flow of the spray gun begins and ends, indicating a discrete spray cycle, and record the volume sprayed according to the flow meter 24 or other method. A microprocessor collects the data electronically and displays the value to the operator, as well as cumulative average and it is envisioned to have a comparison to a target value. The system can ensure that a minimum limit is provided while notifying the operator if a maximum limit has been exceeded. Audible and or visible alarms can be used to notify the operator and the system has the ability to shut off the flow if the volume exceeds a customer defined amount. The system provides a method to collect the discrete data for various process control and optimization purposes.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mold release agent monitoring system for monitoring an amount of mold release agent applied to a molding tool by a spray device, comprising:
a monitoring system for monitoring an amount of mold release agent applied to the molding tool during a discrete spray cycle, and
an indicator system for receiving an output signal from the monitoring system and displaying an amount of mold release agent applied during the discrete spray cycle.

2. The mold release agent monitoring system according to claim 11, wherein the monitoring system provides an output signal to an indicator system for providing an alarm signal when the mold release agent applied during the prior discrete spray cycle does not exceed a predetermined threshold level.

3. The mold release agent monitoring system according to claim 1, wherein the monitoring system records an amount of mold release agent applied during each discrete spray cycle.

4. The mold release agent monitoring system according to claim 1, wherein the monitoring system includes a flow meter for monitoring an amount of mold release agent applied to the molding tool.

5. The mold release agent monitoring system according to claim 1, wherein the monitoring system monitors a total consumption of mold release agent over a determined time period and provides a warning to a consumer of a need to reorder more mold release agent when a remaining mold release agent level falls below a predetermined level.

6. The mold release agent monitoring system according to claim 1, further comprising a shutoff valve in communication with the spray device wherein the monitoring system provides a signal to the shutoff valve to close when a predetermined amount of mold release agent is sprayed during a discrete spray cycle.

7. A mold release agent monitoring system, comprising:
a molding tool;
a supply of mold release agent;
a spray device for applying the mold release agent to the molding tool; and
a monitoring system for monitoring an amount of mold release agent applied to the molding tool during a discrete spray cycle.

8. The mold release agent monitoring system according to claim 7, wherein the monitoring system provides an output signal to an indicator system for indicating an amount of mold release agent applied during the discrete spray cycle.

9. The mold release agent monitoring system according to claim 7, wherein the monitoring system provides an output signal to an indicator system for providing an alarm signal when the mold release agent applied during the prior discrete spray cycle does not exceed a predetermined threshold level.

10. The mold release agent monitoring system according to claim 9, wherein the alarm signal is one of an audible or visual alarm.

11. The mold release agent monitoring system according to claim 7, wherein the monitoring system detects a discrete spray cycle by detecting when flow to the spray device begins and ends.

12. The mold release agent monitoring system according to claim 7, wherein the monitoring system controls an amount of mold release agent applied during a discrete spray cycle.

13. The mold release agent monitoring system according to claim 7, wherein the monitoring system records an amount of mold release agent applied during each discrete spray cycle.

14. The mold release agent monitoring system according to claim 7, wherein the monitoring system limits an amount of mold release agent sprayed during a discrete spray cycle.

15. The mold release agent monitoring system according to claim 7, wherein the monitoring system includes a flow meter for monitoring an amount of mold release agent applied to the molding tool.

16. The mold release agent monitoring system according to claim 7, wherein the monitoring system monitors a total consumption of mold release agent over a determined time period and provides a warning to a consumer of a need to reorder more mold release agent when a remaining mold release agent level falls below a predetermined level.

17. The mold release agent monitoring system according to claim 7, wherein the monitoring system can prevent the molding tool from closing if a predetermined amount of mold release agent isn't applied to the molding tool.

18. The mold release agent monitoring system according to claim 7, further comprising a shutoff valve in communication with the spray device wherein the monitoring system provides a signal to the shutoff valve to close when a predetermined amount of mold release agent is sprayed during a discrete spray cycle.

19. A mold release agent monitoring system for monitoring an amount of mold release agent applied to a molding tool by a spray device, comprising:
a monitoring system for monitoring an amount of mold release agent applied to the molding tool during a discrete spray cycle, wherein the monitoring system monitors a total consumption of mold release agent over a determined time period; and
a warning signal generator for comparing a total consumption of mold release agent to an inventory amount of mold release agent and providing warning signal to a consumer's communication device of a need to reorder more mold release agent when a remaining mold release agent level falls below a predetermined level.

20. The mold release agent monitoring system according to claim 19, wherein the monitoring system records an amount of mold release agent applied during each discrete spray cycle.

21. The mold release agent monitoring system according to claim 19, wherein the monitoring system includes a flow meter for monitoring an amount of mold release agent applied to the molding tool.
